(19) United States
(12) Patent Application Publication
(10) Pub. No.: US 2012/0212474 A1
(43) Pub. Date: Aug. 23, 2012

(54) IMAGE DISPLAY DEVICE AND METHOD OF DRIVING THE SAME

(76) Inventors: Moon-Sang Hwang, Yongin-city (KR); Won-Jun Choe, Yongin-city (KR); Dong-Yong Shin, Yongin-city (KR)

(21) Appl. No.: 13/244,414

(22) Filed: Sep. 24, 2011

(30) Foreign Application Priority Data
Feb. 17, 2011 (KR) 10-2011-0014161

(51) Int. Cl. G09G 5/00

(52) U.S. Cl. 345/212

(57) ABSTRACT

An image display device capable of reducing power consumption. The image display device includes: a position determining unit for determining positions of horizontal lines to which data input to a timing controller are to be supplied; a look-up table (LUT) for storing pre-emphasis voltage information corresponding to the positions of the horizontal lines; the timing controller for transmitting the data and the pre-emphasis voltage information to a data driver; a pre-emphasis voltage generator for generating a pre-emphasis voltage to correspond to the pre-emphasis voltage information from the data driver; and the data driver for supplying the pre-emphasis voltage to data lines in a partial period of a horizontal period and for supplying a data signal in a remaining period of the horizontal period.

### CROSS-REFERENCE TO RELATED APPLICATION

This application claims priority to and the benefit of Korean Patent Application No. 10-2011-0014161, filed on Feb. 17, 2011, in the Korean Intellectual Property Office, the entire content of which is incorporated herein by reference.

### BACKGROUND

1. Field

The following description relates to an image display device and a method of driving the same, and more particularly, to an image display device capable of reducing power consumption and a method of driving the same.

2. Description of Related Art

Recently, various flat panel displays (FPDs) that are lighter in weight and smaller in volume than that of comparable cathode ray tubes (CRT) have been developed. The FPDs include liquid crystal displays (LCDs), field emission displays (FEDs), plasma display panels (PDPs), and organic light emitting displays.

In general, since an image display device including a FPD has advantages of being made small and light and of consuming low power, this type of image display device has been spotlighted as a solution for solving the disadvantages of a comparable cathode ray tube (CRT). Here, the image display device including the FPD is ether mounted in a monitor or a television set that is considered to be a medium or large size product, or mounted in a portable apparatus such as a mobile telephone or a personal digital assistant (PDA).

The image display device includes pixels positioned at the crossings of scan lines and data lines, a scan driver for driving the scan lines, and a data driver for driving data lines.

The scan driver sequentially supplies scan signals to the scan lines and selects the pixels in units of lines. The data driver supplies data signals to the data lines in synchronization with the scan signals. Here, the pixels selected by the scan signals are provided or charged with voltages corresponding to the data signals. The pixels that are provided or charged with the voltages corresponding to the data signals display an image with set or predetermined brightness to correspond to the data signals.

In order for the image display device to stably display an image, the data signals are to be stably supplied to the pixels within a set or predetermined time (that is, a period in which the scan signals are supplied). However, as resolution increases and a panel is enlarged, in the period where the scan signals are supplied, the data signals may not be charged/discharged at a desired voltage.

In order to solve such problems, a method of supplying a pre-emphasis voltage is suggested. In the above method, a larger driving voltage than the data signals is temporarily applied to reduce driving delay time. However, in a comparable embodiment, since the same pre-emphasis voltage is supplied to all of the pixels, a large amount of power is consumed. In addition, in the case of a high resolution panel, in order to stably drive the high resolution panel, the pre-emphasis voltage is to be increased so that an even larger amount of power consumption is consumed. Furthermore, when the large amount of power is consumed by the pre-emphasis voltage, heat of a driving circuit is increased and EMI is also increased.

### SUMMARY

Aspects of embodiments of the present invention are directed toward an image display device capable of reducing power consumption and a method of driving the same.

In an embodiment of the present invention, there is provided an image display device, including: a position determining unit for determining positions of horizontal lines to which data input to a timing controller are to be supplied; a look-up table (LUT) for storing pre-emphasis voltage information corresponding to the positions of the horizontal lines; the timing controller for transmitting the data and the pre-emphasis voltage information to a data driver; a pre-emphasis voltage generator for generating a pre-emphasis voltage to correspond to the pre-emphasis voltage information from the data driver; and the data driver for supplying the pre-emphasis voltage to data lines in a partial period of a horizontal period and for supplying a data signal in a remaining period of the horizontal period.

In one embodiment, the pre-emphasis voltage information stored in the LUT is percent (%) information for determining the voltage level of the pre-emphasis voltage. In one embodiment, a panel is divided into a plurality of blocks each including at least two of the horizontal lines, and the blocks have different percent information items. In one embodiment, the value of the percentage of the percent information is proportional to the distance of a corresponding horizontal line of the horizontal lines, measured away from the data driver. In one embodiment, the pre-emphasis voltage generator is configured to generate the pre-emphasis voltage, by adding a voltage that is generated by multiplying the percent information by a difference in voltage between a current data signal and a previous data signal, to the voltage of the current data signal.

In one embodiment, the timing controller is configured to transmit the pre-emphasis voltage information to the data driver in a horizontal blank period positioned between line data.

In one embodiment, the position determining unit includes a counter for counting the position of a corresponding horizontal line of the horizontal lines to correspond to a horizontal synchronizing signal. In one embodiment, the counter is reset when a vertical synchronizing signal is input.

In one embodiment, information on time for which the pre-emphasis voltage is to be supplied is further stored in the LUT to correspond to the position of a corresponding horizontal line of the horizontal lines. In one embodiment, the image display device further includes a pre-emphasis time controller coupled to the data driver to control time for which the pre-emphasis voltage is to be supplied, to correspond to the time information.

In another embodiment of the present invention, there is provided an image display device, including: a position determining unit for determining positions of horizontal lines to which data input to a timing controller are to be supplied; a look-up table (LUT) for storing pre-emphasis time information corresponding to the positions of the horizontal lines; the timing controller for transmitting the data and the pre-emphasis time information to a data driver; a pre-emphasis time controller for controlling supply time of a pre-emphasis voltage to correspond to the pre-emphasis time information from the data driver; and the data driver for supplying the pre-emphasis voltage to data lines in a horizontal period for a time determined by the pre-emphasis time controller and for supplying a data signal in a remaining period of the horizontal period.

In one embodiment, a panel is divided into a plurality of blocks each including at least two of the horizontal lines, and the blocks have different pre-emphasis time information items. In one embodiment, the pre-emphasis time information is set so that the supply time of the pre-emphasis voltage is proportional to the distance of a corresponding horizontal line of the horizontal lines, measured away from the data driver.

In one embodiment, the timing controller is configured to transmit the pre-emphasis time information to the data driver in a horizontal blank period positioned between line data.

In another embodiment of the present invention, there is a method of driving an image display device, the method including: determining positions of horizontal lines to which data input to a timing controller are to be supplied; extracting previously stored pre-emphasis voltage information so that different pre-emphasis voltages are to be supplied to correspond to the positions of the horizontal lines; generating a pre-emphasis voltage to correspond to the pre-emphasis voltage information; and supplying the pre-emphasis voltage in a partial period of a horizontal period and supplying a data signal generated by the data in a remaining period of the horizontal period.

In the image display device according to one or more embodiments of the present invention and the method of driving the same according to one or more embodiments of the present invention, the voltage level and/or time of the pre-emphasis voltage, are controlled to correspond to the formed horizontal lines of the pixels so that the data signals are stably supplied and power consumption may be simultaneously, concurrently, or commonly reduced. In addition, since the heat and EMI of the driving circuit are reduced to correspond to the reduction of power consumption, the reliability of driving may be improved.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a graph illustrating charge time according to a pre-emphasis voltage;

FIG. 2 is a view illustrating an example of supplying the pre-emphasis voltage;

FIG. 3 is a view illustrating an image display device according to an embodiment of the present invention;

FIG. 4 is a view illustrating pre-emphasis percent information supplied from a timing controller to a data driver;

FIG. 5 is a view illustrating an image display device according to another embodiment of the present invention;

FIG. 6 is a view illustrating the supply time of the pre-emphasis voltage controlled by the pre-emphasis time controller of FIG. 5;

FIG. 7 is a graph illustrating delay according to a pre-emphasis voltage level; and

FIG. 8 is a graph illustrating delay according to pre-emphasis time.

### DETAILED DESCRIPTION

Hereinafter, certain exemplary embodiments according to the present invention will be described with reference to the accompanying drawings. Here, when a first element is described as being coupled to a second element, the first element may be not only directly coupled to the second element, but may also be indirectly coupled to the second element via one or more third elements. Further, some of the elements that are not essential to the complete understanding of the invention are omitted for clarity. Also, like reference numerals refer to like elements throughout.

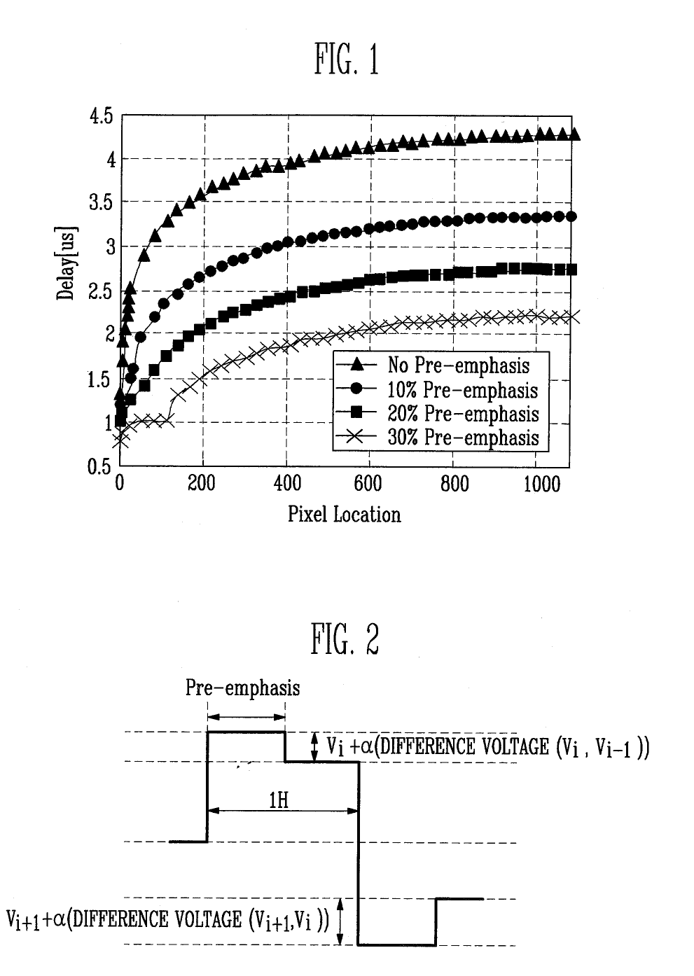

Hereinafter, exemplary embodiments by which those skilled in the art may easily perform the present invention will be described in detail with reference to FIGS. 1 to 8.

FIG. 1 is a graph illustrating charge time according to a pre-emphasis voltage. In FIG. 1, for convenience purposes, the case in which a panel has 1,080 lines will be illustrated. In FIG. 1, the X axis is used to reference the positions of a data driver and horizontal lines, and the Y axis is used to reference the delay times of data signals.

Referring to FIG. 1, the delay times of the data signals are different from each other to correspond to pre-emphasis voltages and the positions of pixels. That is, as the pixels are close to the data driver and a high pre-emphasis voltage is supplied, the charge/discharge times of the data signals are reduced.

Here, when it is assumed that the target charge time of the data signals is 2.75 μs, the data signals may be charged without the pre-emphasis voltage to the pixels positioned from the 1^{st} to the 46^{th} horizontal lines adjacent to the data driver and the data signals may be stably charged to the pixels positioned from the 47^{th} to the 245^{th} horizontal lines when a 10% pre-emphasis voltage is supplied. In addition, the data signals may be stably charged to the pixels positioned from the 246^{th} to the 807^{th} horizontal lines when a 20% pre-emphasis voltage is supplied, and the data signals may be stably charged to the pixels positioned with the remaining horizontal lines when a not less than 30% pre-emphasis voltage is supplied.

Since the not less than 30% pre-emphasis voltage is supplied to all of the pixels considering margin in a comparable embodiment, unnecessary power consumption is consumed. In order to solve the above problem, according to an embodiment of the present invention the pre-emphasis voltage is controlled to correspond to the positions of the pixels in the data driver as illustrated in TABLE 1.

TABLE 1

| | Horizontal lines | | | |
|---|---|---|---|---|
| | 1 to 46 | 47 to 245 | 246 to 807 | 808 to 1,080 |
| Pre-emphasis | None | 10% | 20% | 30% |
| voltage | | | | |

Referring to TABLE 1, according to the present invention, a panel is divided into a plurality of blocks (1 to 46, 47 to 245, 246 to 807, and 808 to 1,080) to correspond to the positions of the data driver and the horizontal lines and different pre-emphasis voltages are supplied to the respective blocks. In this case, the data signals are stably supplied and power consumption may be reduced.

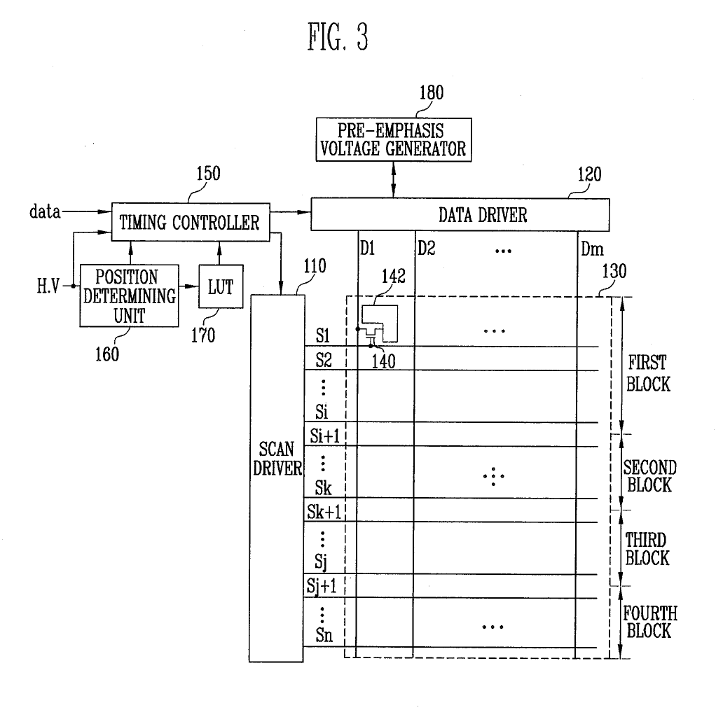

FIG. 2 is a view illustrating an example of supplying the pre-emphasis voltage.

Referring to FIG. 2, the pre-emphasis voltage is supplied at the beginning of a period in which data signals are supplied. The pre-emphasis voltage is supplied as a higher or lower voltage than the current data signal.

In more detail, the voltage of a data line is increased or reduced from a previously supplied voltage (a previous data signal) to a currently supplied voltage (the current data signal). Therefore, the pre-emphasis voltage is determined considering the current data signal and the previous data signal.

That is, according to an embodiment of the present invention, the pre-emphasis voltage is obtained by multiplying a difference in voltage between the voltage of the current data signal and the voltage of the previous data signal, by the percent (%) illustrated in the TABLE 1, and is determined as illustrated in EQUATION 1.

Vp=Vi+α(difference in voltage(Vi,Vi−1)) EQUATION 1

wherein, Vp represents a pre-emphasis voltage, Vi represents a current data signal, Vi−1 represents the voltage of a previous data signal, and α represents the percent (%) determined by TABLE 1.

For example, when the current data signal supplied to the 200^{th} horizontal line is set as 10V and the previous data signal is 0V, the difference in voltage is determined as 10V. When the difference in voltage is determined as 10V, 1V that is 10% of the difference voltage is added so that 11V is supplied as the pre-emphasis voltage.

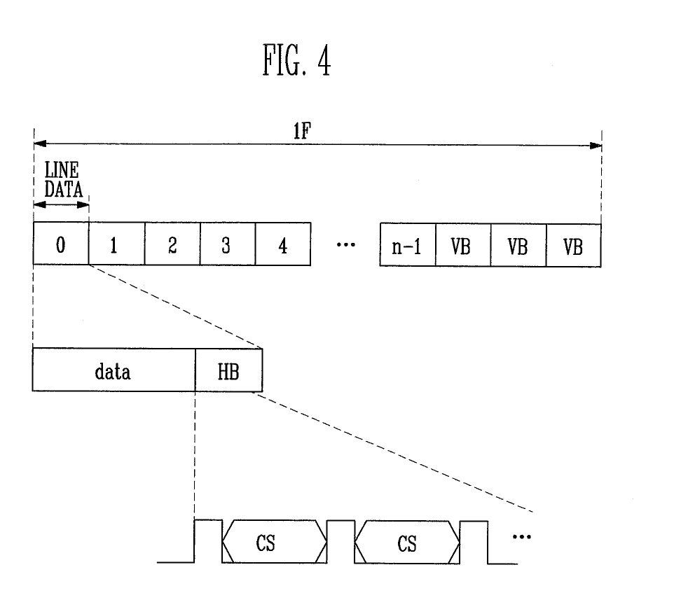

FIG. 3 is a view illustrating an image display device according to an embodiment of the present invention.

Referring to FIG. 3, the image display device includes a panel 130 including pixels positioned at the crossings of data lines D1 to Dm and scan lines S1 to Sn; a data driver 120 for driving the data lines D1 to Dm; a scan driver 110 for driving the scan lines S1 to Sn; and a timing controller 150 for controlling the scan driver 110 and the data driver 120.

Here, the image display device is shown to also include a position determining unit 160 for determining the position of the horizontal line of currently supplied data, a look-up table (hereinafter, referred to as LUT) 170 in which the ratio (%) of the pre-emphasis voltage corresponding to the position of the horizontal line is stored, and a pre-emphasis voltage generator 180 for generating the pre-emphasis voltage.

In FIG. 3, the position determining unit 160 and the LUT 170 are separated from the timing controller 150. However, the position determining unit 160, the LUT 170, and the timing controller 150 may be formed as one integrated circuit (IC). The pre-emphasis generator 180 may also be formed of as one IC together with the data driver 120.

The scan driver 110 sequentially supplies scan signals to the scan lines S1 to Sn. When the scan signals are sequentially supplied to the scan lines S1 to Sn, thin film transistors (TFT) 140 are turned on in units of horizontal lines in response to the scan signals.

The data driver 120 converts data into the data signals in order to supply the data signals of one horizontal line to the data lines D1 to Dm, for every one horizontal period where the scan signals are supplied. Here, the data driver 120 supplies the pre-emphasis voltage in a partial period at the beginning of the one horizontal period and outputs the voltages corresponding to the data signals in the remaining period of the horizontal period.

The panel 130 includes the pixels positioned at the crossings of the scan lines S1 to Sn and the data lines D1 to Dm. The panel 130 is divided into a plurality of blocks (first to fourth blocks) to correspond to the positions of the horizontal lines. Here, each of the blocks includes at least two horizontal lines, and the blocks receive pre-emphasis voltages of different percents (%) as illustrated in TABLE 1.

Each of the pixels includes a TFT 140 and a pixel electrode 142 (of, for example, a liquid crystal display (LCD)). The TFT 140 supplies a data signal from a data line (one of D1 to Dm) to the pixel electrode 142 in response to a scan signal from a scan line (one of D1 to Dm). The pixel electrode 142 drives, for example, liquid crystal positioned between a common electrode and the pixel electrode 142 in response to the data signal in order to control the transmittance of light.

The timing controller 150 controls the scan driver 110 and the data driver 120, and supplies data from the outside to the data driver 120. Then, the timing controller 150 controls the pre-emphasis percent information supplied from the LUT 170 to be provided to the pre-emphasis voltage generator 180 via the data driver 120.

The position determining unit 160 determines the position of the horizontal line to which data input to the timing controller 150 is to be supplied. Therefore, the position determining unit 160 receives a vertical synchronizing signal V and a horizontal synchronizing signal H. For example, the position determining unit 160 is formed to include a counter and increases a counter signal to correspond to the horizontal synchronizing signal H in order to determine (or grasp) the positions of the horizontal lines to which the data are to be supplied. Then, the counter is reset when the vertical synchronizing signal V is supplied.

The percent information of the pre-emphasis voltage is stored in the LUT 170 to correspond to the position of the horizontal line. For example, the percent information may be stored in the LUT 170 to correspond to the position of the horizontal line as illustrated in TABLE 1. The LUT 170 extracts the percent information corresponding to the horizontal line information from the position determining unit 160 and provides the extracted information to the timing controller 150.

The pre-emphasis voltage generator 180 receives the current data signal and the previous data signal from the data driver 120. The pre-emphasis voltage generator 180 receives the pre-emphasis percent information from the data driver 120. The pre-emphasis voltage generator 180 that received the current data signal, the previous data signal, and the pre-emphasis percent information, generates the pre-emphasis voltage as illustrated in EQUATION 1 and supplies the generated pre-emphasis voltage to the data driver 120. Then, the data driver 120 supplies the pre-emphasis voltage at the beginning of the horizontal period in which the current data signal is supplied.

Moreover, the data driver 120 stores the previous data signal for one horizontal period so that the pre-emphasis voltage may be stably generated. For example, capacitors corresponding to the data lines D1 to Dm are formed in the data driver 120, and the previous data signal may be stored in the capacitors.

Additionally, the pre-emphasis percent information supplied from the timing controller 150 to the data driver 120 is supplied as a control signal CS in a horizontal blank (HB) period positioned between line data (data of one horizontal line) as illustrated in FIG. 4. When the pre-emphasis percent information is supplied in the horizontal blank period, the positions of the horizontal lines of the data line may be clearly determined or grasped and an additional line is not added.

In operation, first, data is input to the timing controller 150. At this time, the position determining unit 160 determines or grasps position information on the data (that is, the positions of the horizontal lines) and supplies the grasped information to the LUT 170. The LUT 170 extracts the pre-emphasis percent information corresponding to the position information on the data and supplies the extracted information to the timing controller 150.

The timing controller 150 that received the data and the pre-emphasis percent information supplies the data and the pre-emphasis percent information to the data driver 120 as illustrated in FIG. 4. At this time, the data driver 120 generates the current data signal using the data and supplies the pre-emphasis percent information to the pre-emphasis voltage generator 180.

The pre-emphasis voltage generator 180 that received the pre-emphasis percent information generates a pre-emphasis voltage using the previous data signal, the current data signal, and the pre-emphasis percent information, and supplies the generated pre-emphasis voltage to the data driver 120. Then, the data driver 120 supplies the pre-emphasis voltage to the data lines D1 to Dm at the beginning of the horizontal line and supplies the current data signal in the remaining period.

FIG. 5 is a view illustrating an image display device according to another embodiment of the present invention. When FIG. 5 is described, the same elements as those of FIG. 3 are denoted by the same reference numerals and detailed description thereof will be omitted.

Referring to FIG. 5, the image display device includes a pre-emphasis time controller 200 and an LUT 210.

Pre-emphasis time information is stored in the LUT 210 to correspond to the position of the horizontal line. In FIG. 3, the method of controlling the value of the pre-emphasis voltage to correspond to the position of the horizontal line was described. However, in FIG. 5, the pre-emphasis voltage is uniformly maintained, and time for which the pre-emphasis voltage is supplied, is controlled.

In more detail, as the time for which the pre-emphasis voltage is supplied increases in one horizontal period, the supply of the data signal is stabilized. The times of the pre-emphasis voltage corresponding to the blocks (1 to 46, 47 to 245, 246 to 807, and 808 to 1,080) of the panel are stored in the LUT 210. For example, in the LUT 210, time may be set so that the pre-emphasis voltage is supplied for a longer time as a block is remote from the data driver 120 (e.g., the supply time is proportional to the distance of a block measured away from the data driver 120).

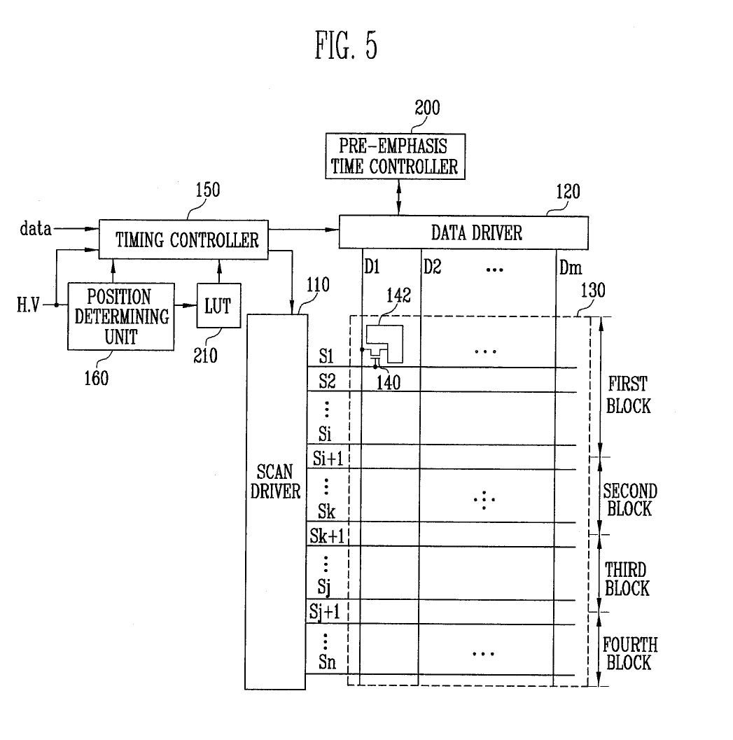

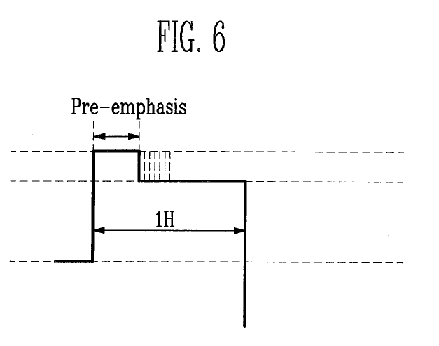

The pre-emphasis time controller 200 receives pre-emphasis time information from the data driver 120. The pre-emphasis time controller 200 that received the pre-emphasis time information controls the data driver so that the pre-emphasis voltage is supplied in the period corresponding to the pre-emphasis time information as illustrated in FIG. 6. Then, the data driver supplies the pre-emphasis voltage to the data lines in the horizontal period for a time determined by the pre-emphasis time controller 200 and supplies a data signal in the remaining period of the horizontal period. Since the other operation processes are the same as those of FIG. 3, detailed description will be omitted.

In the above description, it is described that the voltage level of the pre-emphasis voltage and the supply time of the pre-emphasis voltage are additionally controlled. However, the present invention is not limited to the above. That is, the pre-emphasis voltage generator 180 and the pre-emphasis time controller 200 can be simultaneously, concurrently, or commonly formed in one image display apparatus so that the pre-emphasis voltage level and the supply time may be simultaneously, concurrently, or commonly controlled.

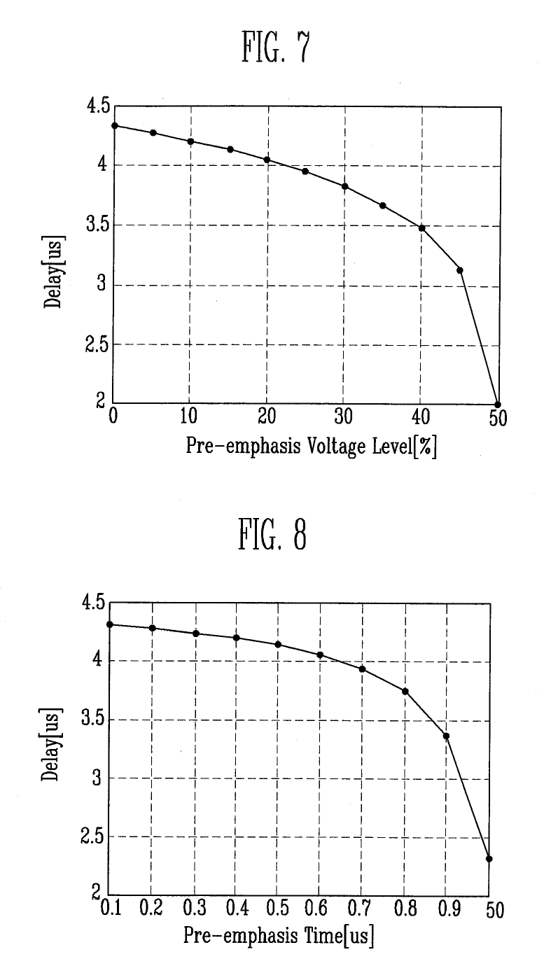

FIG. 7 is a graph illustrating delay according to a pre-emphasis voltage level.

Referring to FIG. 7, as the pre-emphasis voltage is high, the charge delay of the data signal is reduced. According to an embodiment of the present invention, the percent information on the pre-emphasis voltage included in the LUT 170 is experimentally stored to correspond to the resolution, the dimension (inch) of the panel, and the position of the horizontal line so that power consumption may be reduced.

FIG. 8 is a graph illustrating delay according to pre-emphasis time.

Referring to FIG. 8, as time for which the pre-emphasis voltage is supplied is long, the charge delay of the data signal is reduced. According to an embodiment of the present invention, the supply time of the pre-emphasis voltage is experimentally stored in the LUT 210 to correspond to the resolution, the dimension (inch) of the panel, and the position of the horizontal line so that power consumption may be reduced.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. An image display device, comprising:
a position determining unit for determining positions of horizontal lines to which data input to a timing controller are to be supplied;
a look-up table (LUT) for storing pre-emphasis voltage information corresponding to the positions of the horizontal lines;
the timing controller for transmitting the data and the pre-emphasis voltage information to a data driver;
a pre-emphasis voltage generator for generating a pre-emphasis voltage to correspond to the pre-emphasis voltage information from the data driver; and
the data driver for supplying the pre-emphasis voltage to data lines in a partial period of a horizontal period and for supplying a data signal in a remaining period of the horizontal period.

2. The image display device as claimed in claim 1, wherein the pre-emphasis voltage information stored in the LUT is percent (%) information for determining the voltage level of the pre-emphasis voltage.

3. The image display device as claimed in claim 2,
wherein a panel is divided into a plurality of blocks each including at least two of the horizontal lines, and
wherein the blocks have different percent information items.

4. The image display device as claimed in claim 2, wherein the value of the percentage of the percent information is proportional to the distance of a corresponding horizontal line of the horizontal lines, measured away from the data driver.

5. The image display device as claimed in claim 2, wherein the pre-emphasis voltage generator is configured to generate the pre-emphasis voltage, by adding a voltage that is generated by multiplying the percent information by a difference in voltage between a current data signal and a previous data signal, to the voltage of the current data signal.

6. The image display device as claimed in claim 1, wherein the timing controller is configured to transmit the pre-emphasis voltage information to the data driver in a horizontal blank period positioned between line data.

7. The image display device as claimed in claim 1, wherein the position determining unit comprises a counter for counting the position of a corresponding horizontal line of the horizontal lines to correspond to a horizontal synchronizing signal.

8. The image display device as claimed in claim 7, wherein the counter is reset when a vertical synchronizing signal is input.

9. The image display device as claimed in claim 1, wherein information on time for which the pre-emphasis voltage is to be supplied is further stored in the LUT to correspond to the position of a corresponding horizontal line of the horizontal lines.

10. The image display device as claimed in claim 9, further comprising a pre-emphasis time controller coupled to the data driver to control time for which the pre-emphasis voltage is to be supplied, to correspond to the time information.

11. An image display device, comprising:
a position determining unit for determining positions of horizontal lines to which data input to a timing controller are to be supplied;
a look-up table (LUT) for storing pre-emphasis time information corresponding to the positions of the horizontal lines;
the timing controller for transmitting the data and the pre-emphasis time information to a data driver;
a pre-emphasis time controller for controlling supply time of a pre-emphasis voltage to correspond to the pre-emphasis time information from the data driver; and
the data driver for supplying the pre-emphasis voltage to data lines in a horizontal period for a time determined by the pre-emphasis time controller, and for supplying a data signal in a remaining period of the horizontal period.

12. The image display device as claimed in claim 11,
wherein a panel is divided into a plurality of blocks each including at least two of the horizontal lines, and
wherein the blocks have different pre-emphasis time information items.

13. The image display device as claimed in claim 12, wherein the pre-emphasis time information is set so that the supply time of the pre-emphasis voltage is proportional to the distance of a corresponding horizontal line of the horizontal lines, measured away from the data driver.

14. The image display device as claimed in claim 11, wherein the timing controller is configured to transmit the pre-emphasis time information to the data driver in a horizontal blank period positioned between line data.

15. A method of driving an image display device, the method comprising:
determining positions of horizontal lines to which data input to a timing controller are to be supplied;
extracting previously stored pre-emphasis voltage information so that different pre-emphasis voltages are to be supplied to correspond to the positions of the horizontal lines;
generating a pre-emphasis voltage to correspond to the pre-emphasis voltage information; and
supplying the pre-emphasis voltage in a partial period of a horizontal period and supplying a data signal generated by the data in a remaining period of the horizontal period.

16. The method as claimed in claim 15, wherein the pre-emphasis voltage information is percent (%) information for determining the voltage level of the pre-emphasis voltage.

17. The method as claimed in claim 16,
wherein a panel is divided into blocks each including at least two of the horizontal lines, and
wherein the blocks have different percent information items.

18. The method as claimed in claim 16, wherein value of the percentage of the percent information is proportional to the distance of a corresponding horizontal line of the horizontal lines, measured away from a data driver for generating the data signal.

19. The method as claimed in claim 16, wherein the pre-emphasis voltage is generated by adding a voltage generated by multiplying the percent information by a difference in voltage between a current data signal generated by the data and a previous data signal supplied to the data lines, to the voltage of the current data signal.

20. The method as claimed in claim 15, wherein the pre-emphasis voltage information is transmitted from the timing controller to a data driver in a horizontal blank period positioned between line data, the data driver being for generating the data signal.

21. The method as claimed in claim 15, further comprising:
storing pre-emphasis time information so that the pre-emphasis voltage is supplied for different times to correspond to the position of a corresponding horizontal line of the horizontal lines; and
controlling time for which the pre-emphasis voltage is supplied to correspond to the pre-emphasis time information.

22. The method as claimed in claim 21,
wherein a panel is divided into blocks each including at least two of the horizontal lines, and
wherein the blocks have different pre-emphasis time information items.
